(19) United States
(12) Patent Application Publication
(10) Pub. No.: US 2009/0167764 A1
(43) Pub. Date: Jul. 2, 2009

(54) Image Processing Device, Image Processing Method, and Information Storage Medium

(75) Inventor: Norihiro Ohtsuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KONAMI DIGITAL ENTERTAINMENT CO., LTD., Minato-ku, Tokyo (JP)

(21) Appl. No.: 12/089,501

(22) PCT Filed: Oct. 3, 2006
(86) PCT No.: PCT/JP2006/319745

§ 371 Date: Apr. 7, 2008

(30) Foreign Application Priority Data
Oct. 7, 2005 (JP) 2005-295733

(51) Int. Cl. G06T 15/10

(52) U.S. Cl. 345/427

(57) ABSTRACT

To provide an image processing device, an image processing method, and an information storage medium for achieving preferable texture mapping onto a three dimensional model which moves in a virtual three dimensional space. The image processing device (10) for mapping, on each of one or more polygons forming a three dimensional model placed in a virtual three dimensional space, a texture specified by texture coordinates of the polygon and displaying the three dimensional model, comprises a three dimensional model posture changing unit (14a) for changing a posture of the three dimensional model as time passes according to predetermined motion data (18), and a texture coordinate shifting unit (14b) for shifting texture coordinates of the polygon according to change of the posture of the three dimensional model as time passes, which is caused by the three dimensional model posture changing unit (14a).

### TECHNICAL FIELD

The present invention relates to an image processing device, an image processing method, and an information storage medium, and in particular to an image processing device, an image processing method, and an information storage medium for displaying a three dimensional model placed in a virtual three dimension space by means of texture mapping.

### BACKGROUND ART

There is available a so-called 3DCG technique for creating a virtual three dimension space in a computer memory, in which a three dimensional model formed using many polygons is placed for display. According to the 3DCG, in many cases an image (texture) is mapped onto each polygon, using a method referred to as texture mapping. According to texture mapping, with respect to a three dimensional model having front external appearance such as is shown in FIG. 8 A, an original image containing many textures such as is shown in FIG. 8 B is prepared in advance, and a position (indicated by a black circle in FIG. 8 A) within the original image is associated as texture coordinates with each of the vertexes of a polygon forming the three dimensional model. Then, an image of an area within the original image, which is specified by the texture coordinates associated with each vertex of a polygon is pasted to that polygon. According to the texture mapping technique, a three dimensional model can have a variety of external appearances. The following two patent documents disclose an image processing device employing a texture mapping method.

### Patent Document 1: Japanese Patent Laid-open Publication No. 2000-30083

### Patent Document 2: Japanese Patent Laid-open Publication No. 2002-74395

### DISCLOSURE OF THE INVENTION

### Problems to be Solved by the Invention

According to the above-described conventional texture mapping method, in which texture coordinates associated with a vertex of each polygon are fixed, unnatural display may result when the three dimensional model is moved. That is, when two adjacent parts of the three dimensional model are bent according to motion data, a polygon with largely variable area may result near the bent portion, as shown in FIG. 9 A. In this case, the texture to be mapped onto that polygon, which is contained in the original image, is largely deformed when mapped thereon, as shown in FIG. 9 B. This may be disturbing to the viewer.

The present invention has been conceived in view of the above, and aims to provide an image processing device, an image processing method, and an information storage medium for achieving preferable texture mapping onto a three dimensional model which moves in a virtual three dimensional space.

### Means for Solving the Problem

In order to address the above described problem, according to one aspect of the present invention, there is provided an image processing device for mapping, on each of one or more polygons forming a three dimensional model placed in a virtual three dimensional space, a texture specified by texture coordinates of the polygon and displaying the three dimensional model, comprising three dimensional model posture changing means for changing a posture of the three dimensional model as time passes according to predetermined motion data, and texture coordinate shifting means for shifting texture coordinates of the polygon according to change of the posture of the three dimensional model as time passes, which is caused by the three dimensional model posture changing means.

According to another aspect of the present invention, there is provided an image processing method for mapping, on each of one or more polygons forming a three dimensional model placed in a virtual three dimension space, a texture specified by texture coordinates of the polygon and displaying the three dimensional model, comprising a three dimensional model posture changing step of changing a posture of the three dimensional model as time passes according to predetermined motion data, and a texture coordinate shifting step of shifting texture coordinates of the polygon according to change of the posture of the three dimensional model as time passes, which is caused at the three dimensional model posture changing step.

According to still another aspect of the present invention, there is provided an information storage medium storing a program causing a computer to function as means for mapping, on each of one or more polygons forming a three dimensional model placed in a virtual three dimension space, a texture specified by texture coordinates of the polygon and displaying the three dimensional model, three dimensional model posture changing means for changing a posture of the three dimensional model as time passes according to predetermined motion data, and texture coordinate shifting means for shifting texture coordinates of the polygon according to change of the posture of the three dimensional model as time passes, which is caused by the three dimensional model posture changing means.

It should be noted here that the computer may be, for example, a personal computer, a server computer, a home-use game machine, a commercial game machine, a portable game device, a portable phone, a portable data assistant, and so forth. The program may be stored in a computer readable information storage medium, such as a CD-ROM, a DVD-ROM, a ROM cartridge, and so forth.

According to the present invention, the texture coordinates of a polygon change according to the posture change of the three dimensional model as time passes. This makes it possible to prevent extreme expansion of the texture to be mapped onto some polygon alone, so that the three dimensional model can be displayed in a manner without causing the viewer to feel any strange sensation.

In one embodiment of the present invention, the image processing device may further comprise storage means for storing time, data describing the posture of the three dimensional model at the time, a displacement amount of the texture coordinates of at least some of the polygons forming the three dimensional model, all in association with one another, wherein the texture coordinate shifting means shifts the texture coordinates of the polygon according to content stored in the storage means. With this arrangement, it is possible to readily and reliably change the texture coordinates of the polygon in an appropriate manner.

### BRIEF DESCRIPTION OF THE DRAWINGS

FIG. 1 is a perspective view showing a three dimensional model before postural change in an image processing device according to an embodiment of the present invention;

FIG. 2 is a diagram showing one example of a texture original image;

FIG. 3 is a perspective view showing a three dimensional model after postural change in the image processing device according to the embodiment of the present invention;

FIG. 4 is a diagram showing a structure of the image processing device according to the embodiment of the present invention;

FIG. 5 is a diagram showing a structure of motion data which contains key frame texture coordinate shift data;

FIG. 6 is a flowchart of image processing according to the embodiment of the present invention;

FIG. 7 is a diagram showing front external appearance of the three dimensional model displayed in the image processing device according to the embodiment of the present invention;

FIG. 8 is a diagram explaining display of a three dimensional model before deformation according to related art; and

FIG. 9 is a diagram explaining display of the three dimensional model after deformation according to the related art.

### BEST MODE FOR CARRYING OUT THE INVENTION

In the following, a preferred embodiment of the present invention will be described in detail with reference to the accompanying drawings.

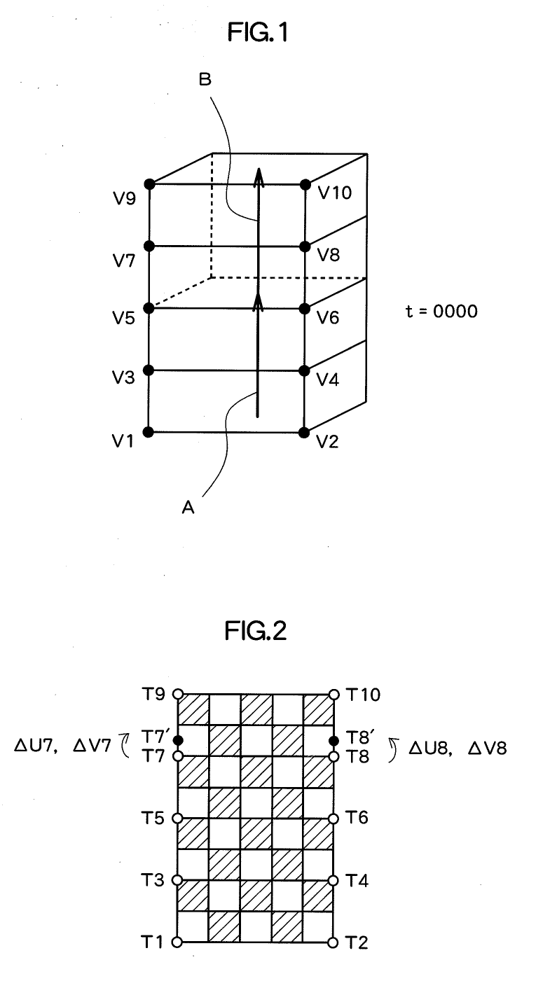

In this embodiment, a virtual three dimension space is created in the memory of a computer, and a three dimensional model (a three dimension object) comprising one or more (a plurality of here) polygons is/are placed in the virtual three dimension space. FIG. 1 is a perspective view showing a shape of the three dimensional model at a certain time (t=0000 here). The shown three dimensional model has a shape formed by placing four rectangular prisms having substantially identical shapes placed one on the other, each specified by eight vertexes. Two bones A, B are set with respect to the three dimensional model such that two upper rectangular prisms change the postures thereof according to the bone A and two lower rectangular prisms change the postures thereof according to the bone B. That is, the postures of the bones A, B change as time passes according to motion data, so that the position of the polygon around the bones A, B accordingly changes as time passes.

It should be noted that the bone is a line segment serving as a reference for a vertex of a polygon around the bone. Specifically, the bone A is placed piercing through the centers of two upper rectangular prisms, for example, and the bone B is placed piercing through the centers of two lower rectangular prisms. It should be noted that although a simply shaped three dimensional model is used here for explanation, one having a more complicated shape, including one representing an item, such as a human body, a living creature, a robot, and so forth, may also be applicable. Also, although it is arranged here such that adjacent polygons share a vertex, adjacent polygons may have separate vertexes. Further, one motion data item may be prepared for either the whole or each part of a three dimensional model.

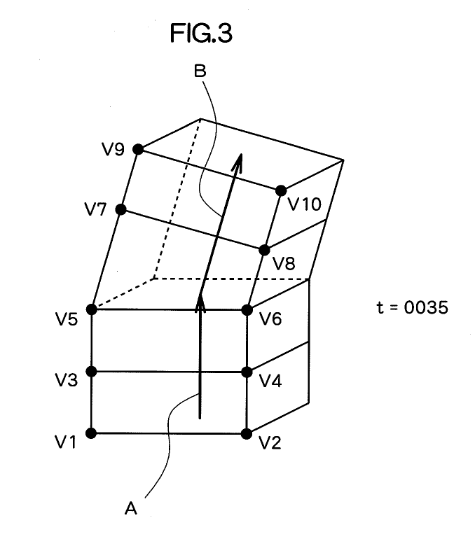

FIG. 2 is a diagram showing a texture original image which contains a texture to be mapped onto the three dimensional model shown in FIG. 1. In this embodiment, texture coordinates are associated with each of the vertexes of each of the polygons which constitute the three dimensional model. The texture coordinates specify a position in the texture original image, and the image of an area in the texture original image, which is surrounded by the texture coordinates associated with the respective vertexes of the polygon concerned is mapped as a texture to that polygon. It is assumed here that, texture coordinates Tn are associated with the vertex Vn shown in FIG. 1.

FIG. 3 shows the three dimensional model shown in FIG. 1, and posture of this model is changed according to motion data, that is, the three dimensional model having the shape at a time point (t=0035 here), or a time point after a predetermined period of time after the time at which the three dimensional model has the shape shown in FIG. 1. It is assumed here that key frames are set successively at t=000 and t=0035 according to the motion data. Whereas the bones A and B are defined on a straight line in FIG. 1, the bone A is defined extending in a direction different from that of the bone B in FIG. 3, with two upper rectangular prisms largely inclining in posture. Accordingly, the polygon in the bent portion has an area largely different from the corresponding area in FIG. 1. For example, the area of the polygon surrounded by the vertexes V5 to V8 has become larger than that before the postural change (see FIG. 1). Consequently, the image of the area surrounded by the texture coordinates T5 to T8 in the texture original image shown in FIG. 2 is enlarged when mapped onto the area. In view of the above, in this embodiment, the texture coordinates T7 are changed to T7′, and the texture coordinates T8 are changed to T8′ That is, the texture coordinates, which have two components in the vertical and horizontal directions, respectively, are changed by adding (ΔU7, ΔV7) to the texture coordinates T7 to obtain texture coordinates T7′, and (ΔU8, ΔV8) to the texture coordinates T8 to obtain texture coordinates T8′.

With the above, a texture having an area defined by the texture coordinates T5, T6, T7′, T8′, which is larger than the corresponding texture before the postural change of the three dimensional model, is mapped onto the polygon surrounded by the vertexes V5 to V8, so that enlarged display of the texture can be suppressed. As described above, in this embodiment, a three dimensional model with a texture mapped thereon can be displayed in a manner without causing a strange sensation in the viewer even when the model changes the posture thereof according to motion data. It should be noted that such change of texture coordinates is preferably applied, when the three dimensional model represents a human body, for example, to a portion of the body bending or leaning backward according to motion data or a portion bending of the arm bending according to motion data.

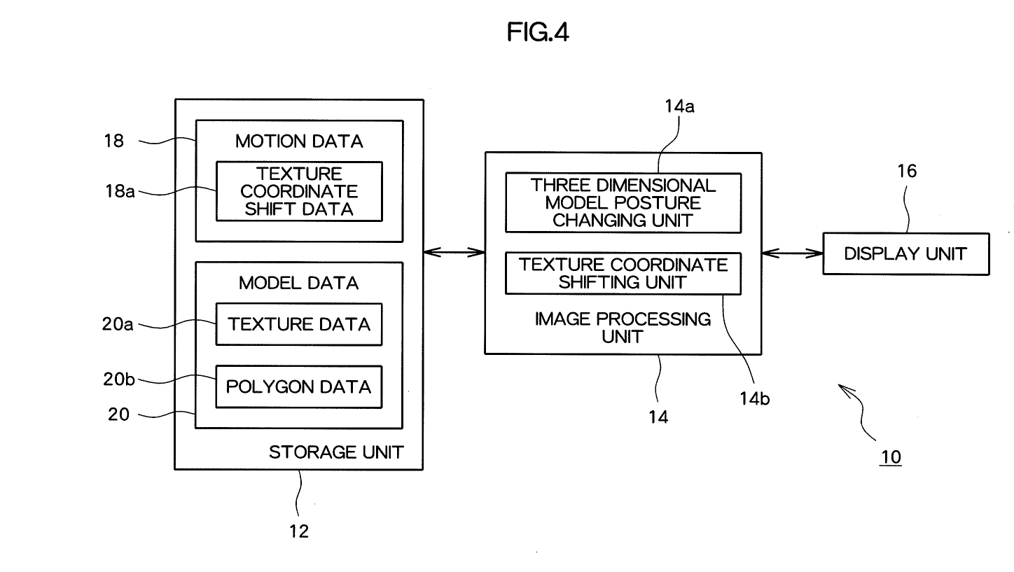

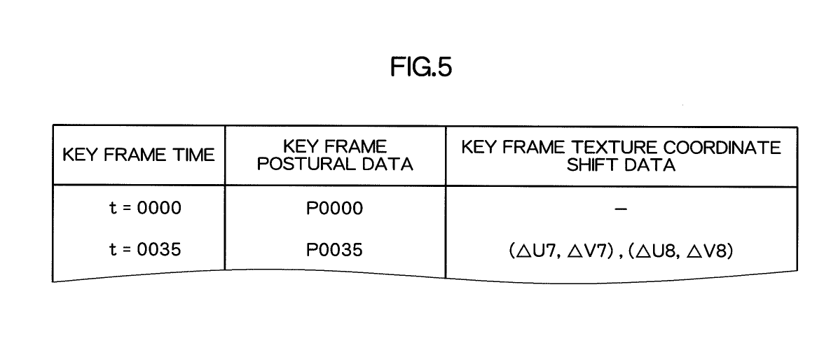

FIG. 4 is a diagram showing a structure of an image processing device according to this embodiment. The shown image processing device 10 comprises a storage unit 12, an image processing unit 14, and a display unit 16. The storage unit 12 comprises a publicly known storage means, such as a hard disk drive, a RAM, or the like, and stores, in particular, motion data 18 and model data 20. The motion data 18 is data about postural change of a three dimensional model (a bone, here), and includes texture coordinate shift data 18a here. The motion data 18 may be data about positional change of a vertex of each polygon forming a three dimensional model. In this case also, postural change of a three dimensional mode is described by the motion data 18. The texture coordinate shift data 18a is data about a shift amount (ΔUn, ΔVn, described above) of the texture coordinates of some or all vertexes of a polygon forming a three dimensional model. FIG. 5 shows one example of motion data 18. As shown, the motion data comprises a key frame time t, postural data Pt of each bone at that time, and a shift amount (ΔUn, ΔVn) at that time of the texture coordinates associated with some or all polygon vertexes, all being associated with one another. As for a key frame of which coordinates remain the same, that is, not shifting (for example, the key frame at t=0000), no shift amount (ΔUn, ΔVn) is stored.

The model data 20 comprises texture data 20a and polygon data 20b. The polygon data 20b is data about a position or the like of each polygon forming a three dimensional model relative to a bone, and specifies the shape of the three dimensional model. The polygon data 20b includes texture coordinates of each polygon vertex. The texture data 20a is data indicative of the above-described texture original image.

The image processing unit 14 is a publicly known computer formed using a CPU, a RAM, and so forth as major elements, which can be formed using a personal computer, a domestic game machine, a commercial game machine, a portable game machine, and so forth. Here, the image processing unit 14 creates a virtual three dimension space in the memory by carrying out a predetermined program, then maps a texture specified by the texture coordinates of a polygon forming the three dimensional model placed in the virtual three dimensional space onto the polygon, and produces an image of a picture obtained by viewing the virtual three dimension space from a predetermined viewpoint. Also, a three dimensional model posture changing unit 14a for changing the posture of a three dimensional model as time passes according to the motion data 18 and a texture coordinate shifting unit 14b for shifting the texture coordinates of each polygon according to the postural change of the three dimensional model as time passes caused by the three dimensional model posture changing unit 14a are realized. The program is provided to the image processing unit 14 stored in a computer readable information storage medium, such as a CD-ROM a DVD-ROM, or the like, for example, or alternatively provided to the image processing unit 14 via a data transmission network, such as the Internet or the like. The display unit 16 is formed using an LCD, a CRT, a home-use television set receiver, or the like, and displays an image representative of the virtual three dimension space, produced by the image processing unit 14.

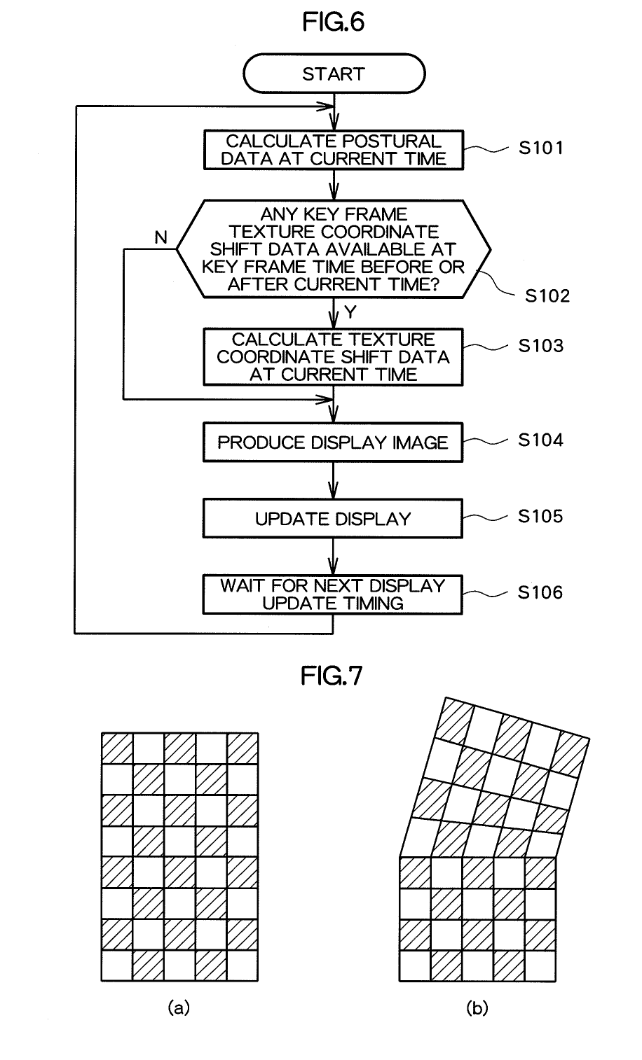

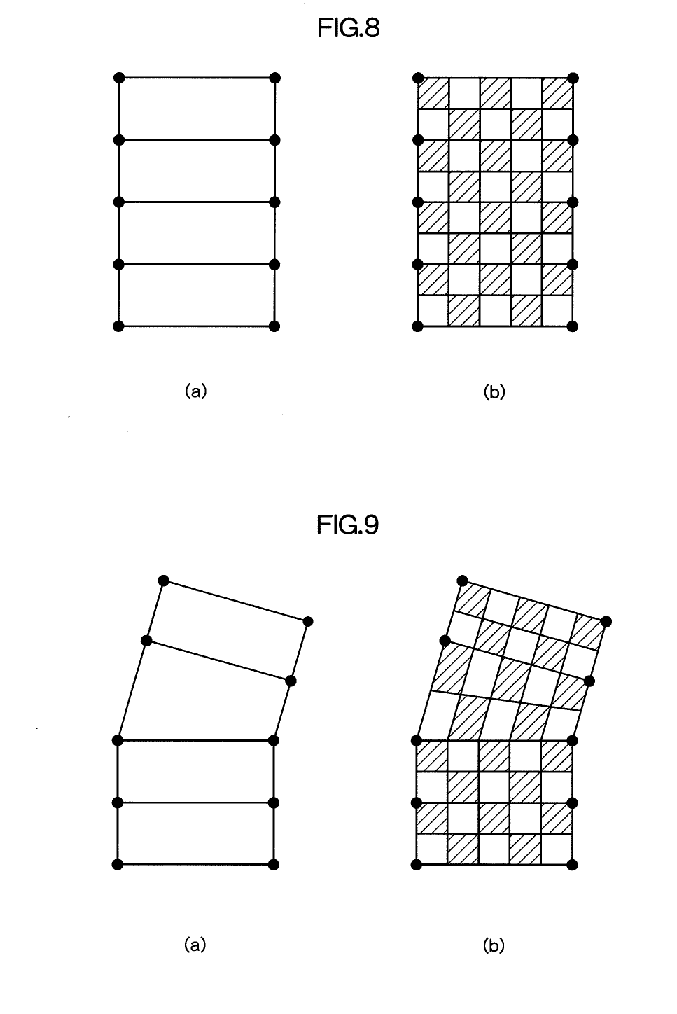

FIG. 6 is a flowchart of an operation of the image processing device 10. As shown, in the image processing device 10, the postural data of the three dimensional model at the current time is calculated based on the motion data 18 (S101). Specifically, the image processing device 10 reads key frame postural data at key frame times before and after the current time from the storage unit 12 and calculates the postural data of each bone of the three dimensional model at the current time by interpolating the key frame postural data. Thereafter, whether or not key frame texture coordinate shift data is stored in association with the key frame time before or after the current time is determined (S102). Then, when it is determined that key frame texture coordinate shift data is stored in association with at least one key frame time, shift amounts of the texture coordinates of each polygon vertex at the current time are acquired based on the data (S103). That is, the image processing device 10 reads the key frame texture coordinate shift data at the key frame times before and after the current time from the storage unit 12 and calculates texture coordinate shift data (representing the shift amount of the texture coordinates) at the current time by interpolating the key frame texture coordinate shift data. Thereafter, the posture of the three dimensional model is updated based on the postural data about each bone, calculated in S101, the shift amount of the texture coordinates, calculated in S103, the model data 20 stored in the storage unit 12, and the image of an area in the texture original image, which is specified by the shifted texture coordinates is mapped onto the three dimensional model in the updated posture, whereby an image representative of the virtual three dimension space at the current time is produced (S104). The produced image is provided to the display unit 16 to update the virtual three dimension space displayed by the display unit 16 (S105). Thereafter, a next display update time is waited for (S106) before the process at S101 and thereafter is carried out. As described above, the process in S101 to S105 is repeated for every predetermined period of time.

According to the above described image processing device 10, the texture coordinates shift in accordance with the postural change of the three dimensional model according to the motion data. This makes it possible to address the deficiency of extremely deformed texture being mapped onto only some of the polygons, so that a three dimensional model which does not subject the viewer to a strange sensation can be displayed. That is, although mapping the texture shown in FIG. 2 onto the three dimensional model (FIG. 1) at time t=0000 results in a natural front external appearance, such as is shown in FIG. 7 A, the three dimensional model at time t=0035 is deformed, as shown in FIG. 3, with largely deformed (distorted) unnatural front external appearance resulting, as shown in FIG. 9 B, when the texture coordinates are not shifted, different from this embodiment. On the contrary, when the coordinates are shifted as desired, similar to this embodiment, as shown in FIG. 7 B, the above described deformation can be suppressed, so that display of the three dimensional model which does not cause the viewer to feel strange can be achieved.

1. An image processing device for mapping, on each of one or more polygons forming a three dimensional model placed in a virtual three dimensional space, a texture specified by texture coordinates of the polygon and displaying the three dimensional model, comprising:
three dimensional model posture changing means for changing a posture of the three dimensional model as time passes according to predetermined motion data; and
texture coordinate shifting means for shifting texture coordinates of the polygon according to change of the posture of the three dimensional model as time passes, which is caused by the three dimensional model posture changing means.

2. The image processing device according to claim 1, further comprising
storage means for storing time, data describing the posture of the three dimensional model at the time, and a shift amount of the texture coordinates of at least some of the polygons forming the three dimensional model, all in association with one another, wherein
the texture coordinate shifting means shifts the texture coordinates of the polygon according to content stored in the storage means.

3. An image processing method for mapping, on each of one or more polygons forming a three dimensional model placed in a virtual three dimensional space, a texture specified by texture coordinates of the polygon and displaying the three dimensional model, comprising:
a three dimensional model posture changing step of changing a posture of the three dimensional model as time passes according to predetermined motion data; and
a texture coordinate shifting step of shifting texture coordinates of the polygon according to change of the posture of the three dimensional model as time passes, which is caused at the three dimensional model posture changing step.

4. An information storage medium storing a program causing a computer to function as
means for mapping, on each of one or more polygons forming a three dimensional model placed in a virtual three dimensional space, a texture specified by texture coordinates of the polygon and displaying the three dimensional model;
three dimensional model posture changing means for changing a posture of the three dimensional model as time passes according to predetermined motion data; and
texture coordinate shifting means for shifting texture coordinates of the polygon according to change of the posture of the three dimensional model as time passes, which is caused by the three dimensional model posture changing means.
